(19) United States
(12) Patent Application Publication
(10) Pub. No.: US 2011/0106832 A1
(43) Pub. Date: May 5, 2011

(54) Method for managing metadata or information about data

(76) Inventors: Stephan Lietz, Bad Salzdetfurth (DE); Karsten Mauler, Vechelde (DE); Christoph Kunze, Sibbesse (DE)

(21) Appl. No.: 11/666,110

(22) PCT Filed: Sep. 6, 2005
(86) PCT No.: PCT/EP2005/054381

§ 371 Date: Jan. 13, 2009

(30) Foreign Application Priority Data
Oct. 22, 2004 (DE) 10 2004 051 458.5

(51) Int. Cl. G06F 17/30

(52) U.S. Cl. 707/769; 707/827; 707/E17.005; 707/E17.014

(57) ABSTRACT

A method for managing metadata about data, these data being transmitted within at least one network by a transmission method, the metadata regarding the data being stored centrally in a program resource manager.

### FIELD OF THE INVENTION

The present invention relates to a method for managing metadata, a program resource manager, a network, a computer program and a computer program product.

### BACKGROUND INFORMATION

Information about data, so-called metadata which are sent within a network, can be managed and/or made available to a user in different ways. In one possible special application, the metadata to be managed may be descriptions of the contents of broadcast channels, e.g., television programs. Such contents are usually made available via TV Guides, but they may also be provided to the user via videotext or possibly the Internet. In the case of digital radio broadcasting (DVB, DAB), these data are broadcast digitally with the actual program.

### SUMMARY OF THE INVENTION

In the method of the present invention for managing metadata, where the data may be of all kinds and these data are transmitted within at least one network by a transmission method, it is provided to store the metadata centrally in a program resource manager possibly disposed centrally in the at least one network. The program resource manager, and therefore the information centrally stored therein, e.g., metadata, can easily be accessed by a user at any time. In particular, it is conceivable to transmit the actual data (i.e., the data to which the metadata relate) on a first network and the metadata on a second network. Thus, for example, transmission of the data via a DVB network and the metadata via a 1394-network or vice versa is possible or conceivable. It is likewise conceivable to form the program resource manager with its own decoder within a network, in order to gather corresponding information or metadata. In this case, the program resource manager would function as client within the network, and would itself procure the necessary or the desired information or metadata. Other clients within the network could query the program resource manager, they themselves furnishing no new information or metadata to the program resource manager.

In the implementation of the method according to the present invention, the metadata and/or the data—the data and the metadata may be linked to each other—are transmitted through channels within the network, and these metadata and/or data are received by network nodes within the network. In this context, data streams contained in the channels may be decoded by the network nodes.

A further advantage of the central storage of information about the metadata transmitted by the transmission method or a broadcast method in the at least one network, is that network nodes are able to retrieve it without having to receive and/or decode specific channels for that purpose.

In a refinement of the present invention, the metadata are extracted by the network nodes. The stored information with respect to the transmitted data, e.g., programs or broadcast transmissions, can be updated jointly by all network nodes that receive the transmitted data. In particular, the metadata may be managed and/or stored in time-dependent fashion by the program resource manager. In so doing, it is conceivable, for instance, to provide the information with time marks.

In a preferred embodiment of the present invention, an overview of the information concerning active channels and/or concerning the data streams contained in the channels may be made available by the program resource manager. Thus, information made available in such a way may be easily retrieved by a user at any time.

Information received by the network nodes may, in particular, be checked automatically and compared to the information of the program resource manager.

The information of the program resource manager can be queried by network nodes and passed on by these network nodes, for example, to users. If a receiver or client, for instance, a device for the audio-visual display of data, is linked to one of the network nodes, then the information is easily visible for the user having the client.

The present invention makes it possible to save on resources which, until now, were necessary for creating a program overview in each of the network nodes, particularly the receiver or the client, for instance, a decoder. Hardware and computing expenditure necessary until now for preparing the program overview may therefore be avoided. In addition to the information with respect to contents of the data, information with respect to topicality of the details stored centrally in the program resource manager may be made available. The possibility is thereby yielded that, upon retrieval or update of these details, the network nodes will possibly assess their validity. In this context, as a matter of priority, details regarding information which is old and therefore more probably invalid may be updated.

For example, the data transmittable within the at least one network by the transmission method via the channels may involve transport streams having compressed audio-visual data or data files, for instance, in MPEG-2 format. A plurality of audio and/or video channels may be combined in one multiplex using these transport streams. It is also conceivable that the metadata are descriptions of audio-visual broadcast transmissions and/or programs whose contents, e.g., summaries or other information are made available in clear fashion using the method of the present invention.

Usually, a network node is merely informed about which data streams and/or metadata are transmitted in that channel or those channels which it is receiving at the moment and whose data streams this network node is possibly decoding. In networks having dynamically changing contents or information with respect to data, network nodes located therein would be compelled to decode all channels and the data streams contained therein, for example, in MPEG-2 format, to be able to continuously assemble an overview of the available programs. Using the present invention, it is now possible at any time to easily retrieve the information stored centrally in the program resource manager.

Networks having dynamically changing contents may, for example, be multimedia networks in motor vehicles or other vehicles. In such networks, it is possible to transmit both local contents, e.g., broadcasts of a DVD playback device, as well as contents from radio broadcasting. For instance, contents from radio broadcasting may be DVB-T multiplexes that typically cannot be received everywhere. Should such a DVB-T multiplex not be available at times, according to the present invention, another multiplex may be selected and injected into the network, without network nodes registering such a change.

The program resource manager according to the present invention, which may be implemented within at least one network in which data are transmittable by a transmission method, is designed to centrally store information with respect to these data.

In the network of the present invention in which data are transmitted by a transmission method, a program resource manager is implemented that is designed for the central storage of information regarding this data.

The program resource manager implemented in the network may be assigned to a network node, for instance, a transmission server. The program resource manager makes information about active channels, data streams and/or contents or information regarding data centrally available. For example, this may be accomplished via storage areas within the at least one network, to which all network nodes have reading and writing access.

The information concerning the data may be updated by all network nodes. When one of the network nodes receives and decodes data transmitted by the transmission method, it is able to check the decoded information and compare it to the information of the program resource manager. Moreover, the network node is able to check and update the information of the program resource manager if it should be in a wait or stand-by phase.

The network nodes are able to query the information of the program resource manager and make it available in the form of a program overview to a user via a receiver or client without, to this end, having to check each channel for its contents. The program resource manager is able to provide an overview of information with respect to the data in the form, for example, of an overview table, which can be generated, updated and retrieved by all network nodes.

The program resource manager of the present invention may be a storage unit or a processing unit within a device, suitable for the transmission of data, of the at least one network.

In a possible embodiment of the present invention, the program resource manager may be a data file, a software or a computer program which is present or stored within the network, and runs and/or is generated in the network.

The computer program according to the present invention having program code means is designed for implementing all steps of the method according to the present invention when this computer program is executed on a computer or a suitable processing unit, particularly one of the devices according to the present invention, like the program resource manager of the present invention or the network according to the present invention.

The computer program product according to the present invention having program code means that are stored on a machine-readable storage medium is provided for implementing all steps of the method according to the present invention when this computer program is executed on a computer or a suitable processing unit, in particular one of the devices according to the present invention, like the program resource manager of the present invention or the network according to the present invention.

### BRIEF DESCRIPTION OF THE DRAWING

FIG. 1 shows a schematic representation of a preferred specific embodiment of the present invention.

### DETAILED DESCRIPTION

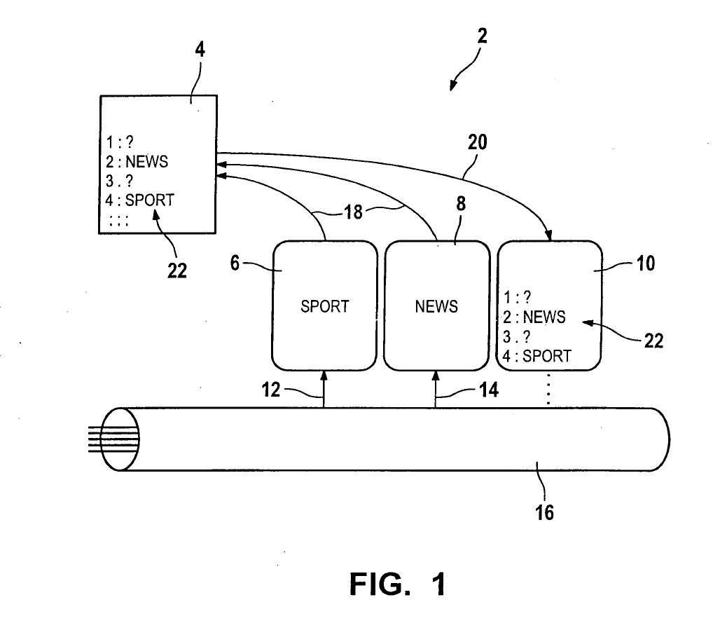

FIG. 1 shows a schematic representation of a specific embodiment of a network 2 according to the present invention, within which data provided with metadata are transmitted by a transmission method. This network 2 includes a plurality of channels 12, 14, 16 for transmitting these data, as well as network nodes 6, 8, 10 for receiving these data. In addition, network 2 of the present invention has a program resource manager (PRM) 4 according to the present invention, represented schematically in the preferred specific embodiment.

In the present exemplary embodiment, a first network node 6 to which, for instance, a first client or receiver for a user is linked, receives data, metadata regarding this data, e.g., data “SPORT” relating to sport, being included. Via a second channel 14, a second network node 8, to which a client or receiver for a user is likewise linked, receives data which includes “NEWS” as metadata.

In a first step 18 of the method according to the present invention, the metadata

“SPORT” and “NEWS”, respectively, associated with the data of the two channels 12, 14, are relayed to program resource manager 4. Such a relay may be carried out as a function of a possible change of the metadata “SPORT” and “NEWS” over time, possibly accompanied by constant update.

The metadata “SPORT” and “NEWS” are centrally stored and/or managed in program resource manager 4, particularly in time-dependent fashion. In this context, in a possible specific embodiment, program resource manager 4 of the present invention creates an overview 22, e.g., in table form, having all information with respect to the data that are transmitted or are potentially transmittable within the network by the transmission method via channels 12, 14, 16 to network nodes 6, 8, 10.

In a further step 20, it is provided that a new user linked via a client or receiver to network node 10, but not yet connected to any of channels 16, retrieves from program resource manager 4 the centrally stored information regarding the data transmitted within network 2 by a transmission method. In the following example, to that end, network node 10 retrieves overview 22 of the information regarding the data and makes it available to the new user via a client or a receiver.

1-12. (canceled)

13. A method for managing metadata, the metadata being information regarding data, the method comprising:
transmitting the data and the metadata within at least one network by one of a broadcast and transmission method; and
storing the metadata centrally in a program resource manager.

14. The method according to claim 13, wherein the data is transmitted through channels within the network, and is received by network nodes within the network.

15. The method according to claim 14, further comprising decoding data streams, contained in the channels, for the data by the network nodes.

16. The method according to claim 14, further comprising at least one of extracting and updating information regarding the data by the network nodes.

17. The method according to claim 13, further comprising at least one of managing and storing the metadata in time-dependent fashion by the program resource manager, the metadata being provided with time marks.

18. The method according to claim 13, wherein at least one of metadata with respect to active channels and metadata with respect to data streams contained in the channels is made available by the program resource manager.

19. The method according to claim 14, wherein metadata received by the network nodes is checked automatically and compared to metadata of the program resource manager.

20. The method according to claim 14, wherein the metadata is queried by the network nodes and passed on by the network nodes.

21. A program resource manager embodied within at least one network in which data is transmitted by a transmission method, comprising:
an arrangement for centrally storing metadata, the metadata being information regarding the data.

22. A network in which data is transmitted by a transmission method, comprising:
a program resource manager for a central storage of metadata regarding the data.

23. A computer-readable medium containing a computer program which when executed by a processor performs the following method for managing metadata, the metadata being information regarding data:
transmitting the data and the metadata within at least one network by one of a broadcast and transmission method; and
storing the metadata centrally in a program resource manager.
